(19) United States
(12) Patent Application Publication
(10) Pub. No.: US 2016/0079907 A1
(43) Pub. Date: Mar. 17, 2016

(54) FIELD-ASSEMBLED AC PHOTOVOLTAIC MODULE

(71) Applicant: SunEdison LLC, Beltsville, MD (US)

(72) Inventors: Miles C. Russell, Lincoln, MA (US); Magnus Asbo, Oakland, CA (US)

(21) Appl. No.: 14/489,178

(22) Filed: Sep. 17, 2014

(51) Int. Cl. H01L 31/042; H02S 50/10; H02S 40/32; H02J 3/38

(52) U.S. Cl. CPC H02S 20/00; H02J 3/38; H02S 50/10; H02S 40/32

(57) ABSTRACT

This disclosure generally relates to methods of assembling an alternating current (AC) photovoltaic (PV) module, including a direct current (DC) PV module and a micro-inverter, at an assembly location. One example method includes assembling the AC PV module by mechanically attaching and electrically grounding the micro-inverter to the DC PV module, testing a DC electrical continuity between the DC PV module and the micro-inverter, and labeling the AC PV module as compliant with a code or standard.

### FIELD

This disclosure generally relates to methods for assembling alternating current (AC) photovoltaic (PV) modules at an assembly location.

### BACKGROUND

Solar modules are devices that convert solar energy into other forms of useful energy (e.g., electricity or thermal energy). Electricity generated by PV modules is typically direct current (DC) electricity. Micro-inverters are used to convert DC electricity from a DC PV module to AC for use in a utility grid. The combination of a DC PV module and a micro-inverter is an AC PV module. Various electrical codes and safety standards require testing and proper labeling when assembling an AC PV module.

AC PV modules are generally assembled at a manufacturing facility before being delivered to an assembly or installation location.

This Background section is intended to introduce the reader to various aspects of the art that may be related to various aspects of the present disclosure, which are described and/or claimed below. This discussion is believed to be helpful in providing the reader with background information to facilitate better understanding of the various aspects of the present disclosure. Accordingly, it should be understood that these statements are to be read in this light, and not as admissions of prior art.

### BRIEF SUMMARY

One aspect of this disclosure is a method of assembling an alternating current (AC) photovoltaic (PV) module, including a micro-inverter and a direct current (DC) PV module with a frame, at an assembly location. The method includes assembling the AC PV module by mechanically attaching and electrically grounding the micro-inverter to the DC PV module, connecting a first DC electrical connector on the DC PV module to a second DC electrical connector on the micro-inverter, and securing a first AC electrical connector on the micro-inverter to the AC PV module frame. The method also includes testing a DC electrical continuity between the DC PV module and the micro-inverter. The method further includes labeling the AC PV module as certified compliant with a code or standard.

Another aspect is a method of assembling a PV system at an assembly location, the PV system comprising a first and second AC PV module, each AC PV module including a DC PV module and a micro-inverter at an assembly location. The method includes assembling the first AC PV module by connecting a first DC electrical connector on a first DC PV module to a second DC electrical connector on a first micro-inverter. The method includes testing a DC electrical continuity between the first DC PV module and the first micro-inverter. The method includes labeling the first AC PV module as certifies compliant with a code of standard. The method also includes assembling the second AC PV module by connecting a third DC electrical connector on a second DC PV module to a fourth DC electrical connector on a second micro-inverter. The method also includes testing a DC electrical continuity between the second DC PV module and the second micro-inverter. The method also includes labeling the second AC PV module as certified compliant with the code or standard. The method further includes connecting the first AC PV module to the second AC PV module by connecting a first AC electrical connector on the first micro-inverter to a second AC electrical connector on the second micro-inverter.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a perspective view of an example solar module.

FIG. 2 is a cross-sectional view of the solar module shown in FIG. 1 taken along the line A-A.

FIG. 3 is an underside view of the solar module shown in FIG. 1.

FIG. 4 is an enhanced view of the underside view of the solar module shown in FIG. 3.

FIG. 5 is a flowchart of a method of assembling an AC PV module at an assembly location.

FIG. 6 is a flowchart of a method of assembling an AC PV module system.

Corresponding reference characters indicate corresponding parts throughout the several views of the drawings.

### DETAILED DESCRIPTION

This disclosure generally relates to methods for assembling AC PV modules at an assembly location.

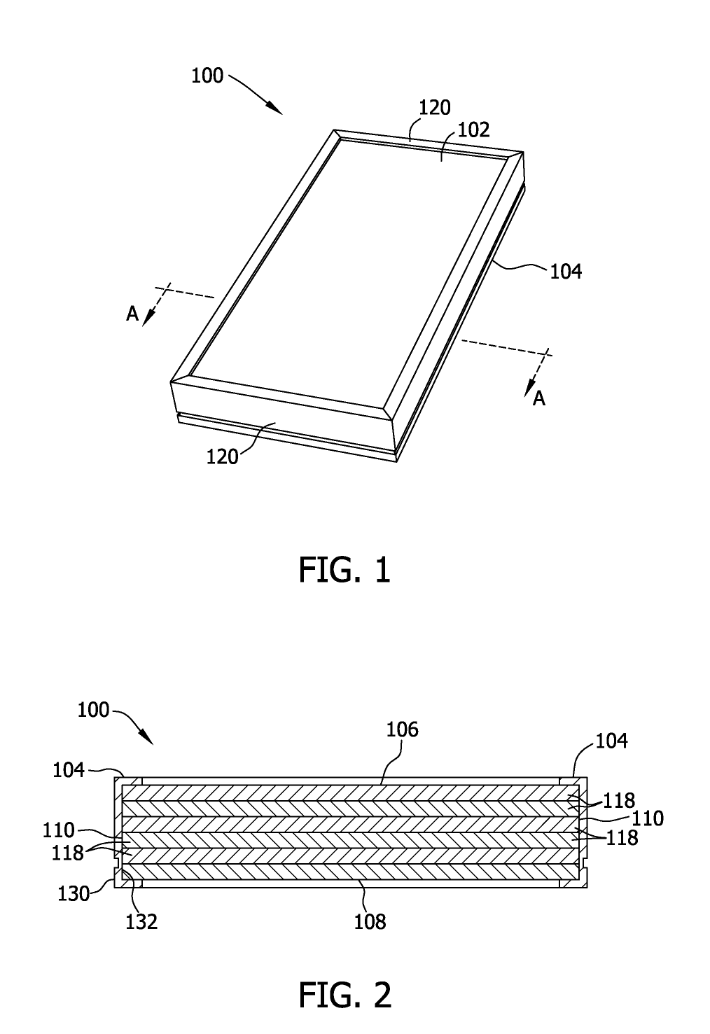

Referring initially to FIGS. 1 and 2, a solar module of one embodiment is indicated generally at 100. A perspective view of solar module 100 is shown in FIG. 1. FIG. 2 is a cross-sectional view of solar module 100 taken at line A-A as shown in FIG. 1. Solar module 100 includes a solar laminate 102 and a frame 104 circumscribing solar laminate 102.

Solar laminate 102 includes a top surface 106 and a bottom surface 108 (shown in FIG. 2). Edges 110 extend between top surface 106 and bottom surface 108. In this embodiment, solar laminate 102 is rectangular shaped. In other embodiments, solar laminate 102 may have any suitable shape.

As shown in FIG. 2, the solar laminate 102 has a laminate structure that includes several layers 118. Layers 118 may include, for example, glass layers, non-reflective layers, electrical connection layers, n-type silicon layers, p-type silicon layers, and/or backing layers. One or more layers 118 may also include solar cells (not shown). In other embodiments, solar laminate 102 may have more or fewer, including one, layers 118, may have different layers 118, and/or may have different types of layers 118.

As shown in FIG. 1, frame 104 circumscribes solar laminate 102. Frame 104 is coupled to solar laminate 102, as best shown in FIG. 2. Frame 104 assists in protecting edges 110 of solar laminate 102. Example frame 104 includes an outer surface 130 spaced apart from solar laminate 102 and an inner surface 132 adjacent solar laminate 102. Outer surface 130 is spaced apart from and substantially parallel to inner surface 132. In the example embodiment, frame 104 is made of aluminum. More particularly, in some embodiments frame 104 is made of 6000 series anodized aluminum. In other embodiments, frame 104 may be made of any other suitable material providing sufficient rigidity including, for example, rolled or stamped stainless steel, plastic, or carbon fiber.

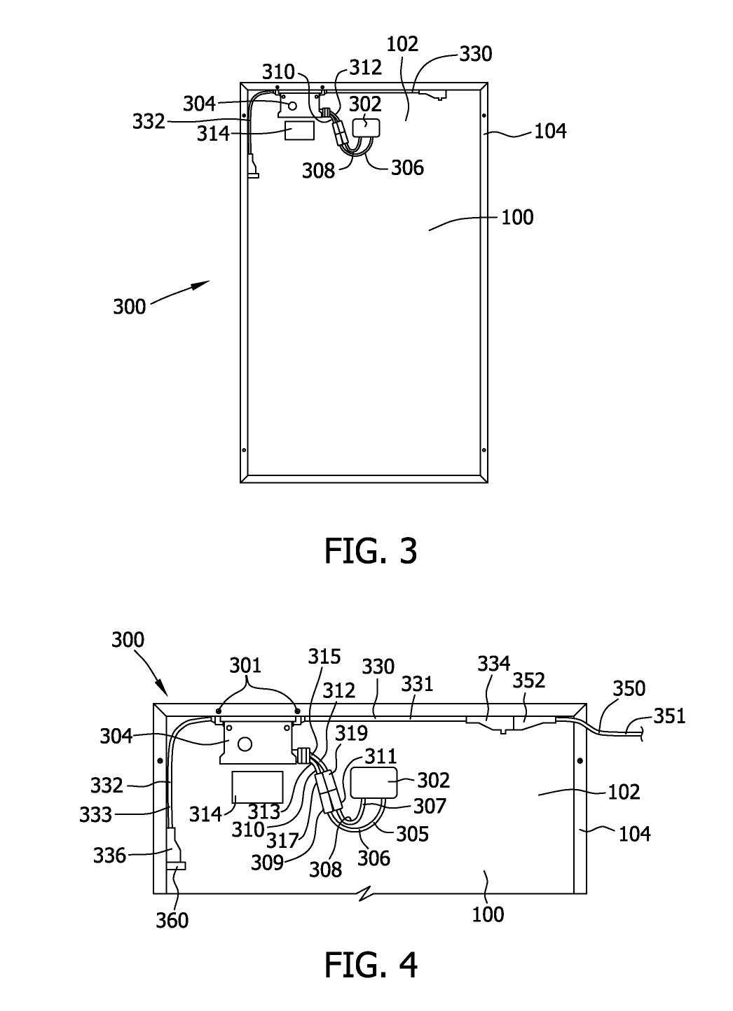

FIGS. 3 and 4 provide an example embodiment of an AC PV module 300. AC PV module 300 includes solar module 100, a DC junction box 302, a micro-inverter 304, and a label 314. Solar module 100, also referred to herein as a DC PV module, generates DC electrical energy and transfers it to junction box 302.

Junction box 302 includes DC electrical connecters, shown generally at 306 and 308, for transferring DC electricity from solar module 100. As shown in FIG. 4, DC electrical connecter 306 includes an electrical cable 305 and a plug 309. DC electrical connecter 308 includes an electrical cable 307 and a plug 311. Electrical cable 305 is connected to junction box 302 at one end and has plug 309 attached at the opposite end. Electrical cable 307 is connected to junction box 302 at one end and has plug 311 attached at the opposite end. The length of each electrical cable 305 and 307 is limited such that no portion of the cable can reach and contact frame 104 or other grounded metal in AC PV module 300. In particular, the end (e.g., with plugs 309 and 311) opposite the end attached to junction box 302 cannot reach and contact frame 104 or other grounded metal in AC PV module 300. In an alternative embodiment, electrical cables 305 and 307 are standard-length cables, but are coiled and/or secured to the AC PV module 300 (e.g., attached to junction box 302, attached to solar module 100, etc.) such that no part of electrical cables 305 and 307 can reach and contact frame 104 or other grounded metal in AC PV module 300. DC electrical connectors 306 and 308 are configured to indicate an electric polarity (i.e., positive or negative) and allow the flow of DC electricity. In an alternative embodiment, connectors 306 and 308 are formed as a single connector. In yet another embodiment, DC electrical connectors 306 and 308 only include plugs 309 and 311 directly attached to junction box 302.

Micro-inverter 304 is mechanically attached and electrically grounded to solar module 100. Specifically, a fastener 301 (shown in FIG. 4) extending through frame 104 engages micro-inverter 304 to mechanically attach and electrically ground micro-inverter 304 to solar module 100. In the example embodiment, micro-inverter 304 is not otherwise grounded to solar module 100. Fastener 301 may be a screw, rivet, bolt, or any other type fastener constructed of electrically conductive material.

Micro-inverter 304 includes DC electrical connectors 310 and 312 and AC electrical connectors 330 and 332. DC electrical connector 310 includes a cord 313 and a plug 317. DC electrical connector 312 includes a cord 315 and a plug 319. Cord 313 is connected to micro-inverter 304 at one end and has plug 317 attached at the opposite end. Cord 315 is connected to micro-inverter 304 at one end and has plug 319 attached at the opposite end. DC electrical connectors 310 and 312 are constructed so as indicate an electric polarity (i.e., positive or negative) and allow the flow of DC electricity. In the illustrated embodiment, DC electrical connectors 310 and 312 are complementary and mate with DC electrical connectors 306 and 308, respectively, to allow DC electricity to flow from junction box 302 to micro-inverter 304. In an alternative embodiment, connectors 310 and 312 may be formed as a single connector. In yet another embodiment, connectors 310 and 312 only include plugs 317 and 319, for example, directly attached to micro-inverter 304.

Micro-inverter 304 is compliant with, and includes a label indicating micro-inverter 304 is certified compliant with, one or more codes and standards. In an example embodiment, micro-inverter 304 is certified compliant with one or more of: Underwriters Laboratories (UL) Standard 1741 (Standard for Inverters, Converters, Controllers, and Interconnection System Equipment for Use with Distributed Energy Resources); UL Standard 1703 (Standards for Flat-Plate Photovoltaic Modules and Panels); Federal Communications Commission (FCC) Class B Electromagnetic Compatibility (EMC); Institute of Electrical and Electronics Engineers (IEEE) Standard 929-2000 (Utility Interface for Residential PV Systems); IEEE Standard C62.41-1991 (Surge Voltages in Low-Voltage AC Power Circuits); IEEE Standard C62.45-1992 (Surge Testing for Equipment Connected to AC Power Circuits); IEEE Standard 1547 (Interconnecting Distributed Resources with the Electrical Power System); IEEE Standard 1547.1 (Conformance Test Procedures for Equipment Interconnecting Distributed Resources with Electric Power Systems); and National Electric Code (NEC) Sections 690.52 and 690.33 (AC Module Labeling).

AC electrical connector 330 includes a cord 331 and a plug 334, and AC electrical connector 332 includes a cord 333 and a plug 336. Cord 331 is connected to micro-inverter 304 at one end and has plug 334 attached at the opposite end. Cord 333 is connected to micro-inverter 304 at one end and has plug 336 attached at the opposite end. Connectors 330 and 332 are formed so as to allow the flow of AC electricity. In an alternative embodiment, one or both connectors 330 and 332 include plug 334 or 336, respectively, attached to micro-inverter 304 (i.e., without a cord 331 or 333). Connectors 330 and 332 are configured for connection to complementary connectors of, for example, another AC PV module.

Label 314 indicates that the AC PV module 300 is certified compliant with requirements of an electrical code or standard, a mechanical code or standard, a manufacturing code or standard, and a safety code or standard. Examples of these standards and codes for which AC PV module 300 may be certified compliant with include the following: UL Standard 1741; UL Standard 1703; FCC Class B EMC; IEEE Standard 929-2000; IEEE Standard C62.41-1991; IEEE Standard C62.45-1992; IEEE Standard 1547; IEEE Standard 1547.1; and NEC Sections 690.52 and 690.33. In some embodiments, label 314 includes the date of manufacture, serial number, and manufacturer's name for module 300.

Methods for certifying AC PV module 300 as compliant with example codes and standards provided above varies depending upon the specific code or standard. Methods for certifying AC PV module 300 may include testing reviewed by an appropriate board or organization. In the exemplary embodiment, solar module 100 is a listed (e.g., a UL listed or ETL listed) DC PV module, and micro-inverter 304 is a listed micro-inverter. Certifying AC PV module 300 includes testing, listing, and labeling the assembled AC PV module 300 consistent with the requirements of UL Standard 1741.

Referring to FIG. 4, AC electrical connector 330 on micro-inverter 304 is attached to another AC PV module or a utility (not shown) by an AC utility electrical connector 350. The utility (not shown) may be an electrical power grid, a building power grid, and/or any piece of equipment or machinery requiring AC electrical power. AC utility electrical connector 350 includes a cord 351 and a plug 352. In the illustrated embodiment, AC electrical connector 330 is complementary and mates with AC utility electrical connector 350 to deliver AC electricity from the AC PV module 300 to the utility (not shown). In the illustrated embodiment, the connection between plugs 334 and 352 is positioned between frame 104 and solar laminate 102. In another embodiment, the connection between plugs 334 and 352 is secured to frame 104. In yet another embodiment, cord 331 is also positioned and secured between frame 104 and solar laminate 102.

Referring again to FIG. 4, AC electrical connector 332 is attached to an end cap 360. Specifically, end cap 360 is attached to plug 336. End cap 360 is designed to protect the end of connector 332 from damage and/or to terminate the electrical circuit including micro-inverter 304. In the illustrated embodiment, the connection between plug 336 and end cap 360 is positioned between frame 104 and solar laminate 102. In an alternative embodiment, the connection between plug 336 and end cap 360 is secured to frame 104. In another embodiment, cord 333 is also positioned and secured between frame 104 and solar laminate 102. In yet another embodiment, connector 332 may connect to a second AC PV module (not shown). In still another embodiment, the connection between plug 336 and end cap 360 is positioned between frame 104 and solar laminate 102 at a distance from where the connection between plugs 334 and 352 is positioned between frame 104 and solar laminate 102.

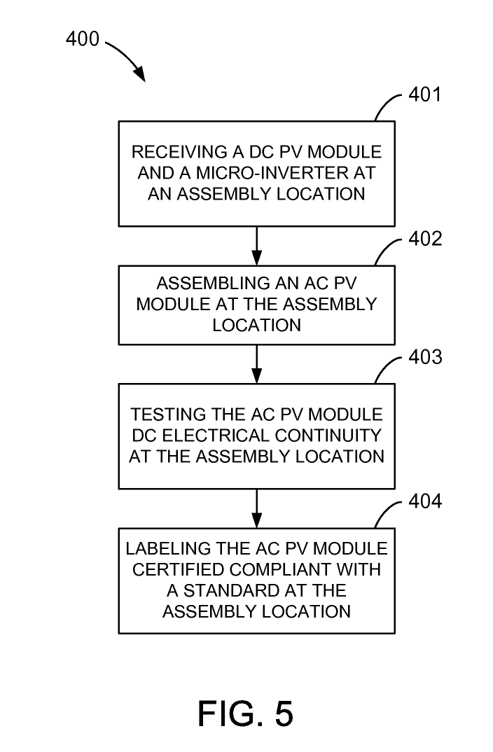

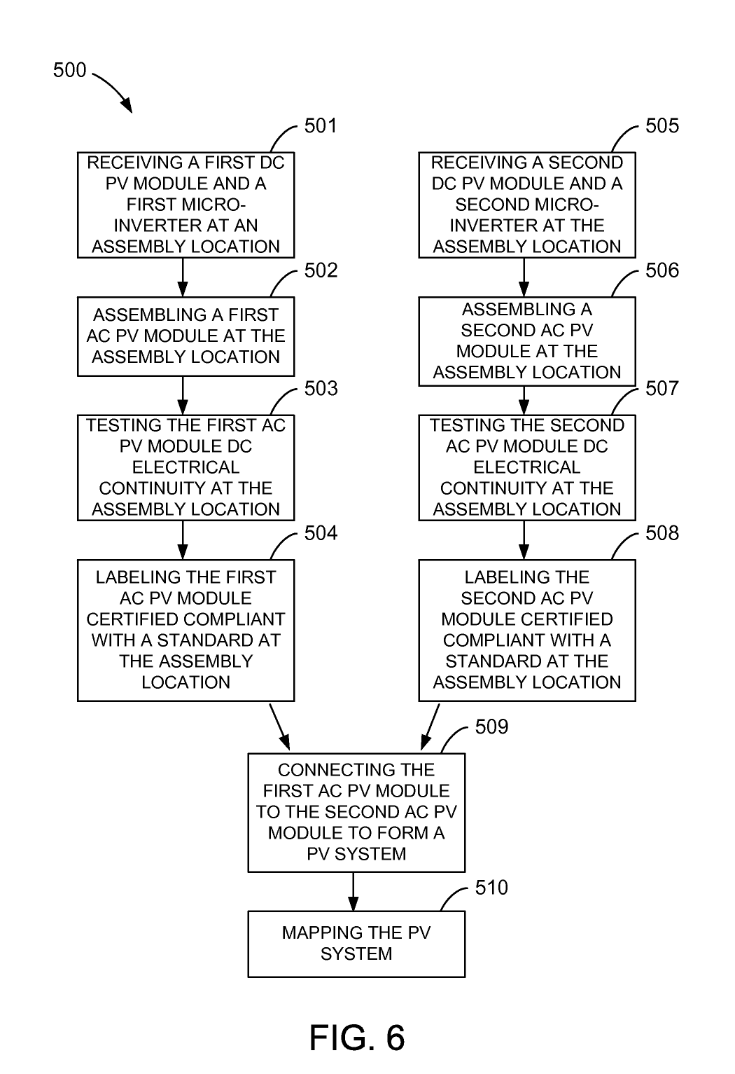

Referring to FIGS. 5 and 6, example methods 400 and 500 of assembling an AC PV module system are provided. Example methods 400 and 500 are performed at an assembly location. The assembly location may be, for example, at an installer's workshop, at a DC PV module or micro-inverter distribution facility, or at an installation site of the AC PV module or PV assembly. The distribution facility is a location where DC PV modules and/or micro-inverters are stocked and/or sold, but not manufactured. The installation site may be, for example, on the roof of a building where an AC PV module is going to be installed. The installation site may also be, for example, adjacent to (e.g., outside, in a workshop, in a vehicle, etc.) a building where an AC PV module is going to be installed. The installation site may also be inside a building where an AC PV module is going to be installed. The installation site may also be, for example, next to a terrestrial installed rack assembly upon which an AC PV module is going to be installed. In some embodiments, one or more steps of method 400 or 500 may be performed at different assembly locations or installation sites than one or more other steps. In exemplary embodiments, the assembly location is not at a DC PV module or micro-inverter manufacturing facility.

Methods 400 and 500 also include steps that are performed by an AC PV module installer. The AC PV module installer may be, for example, an individual person or a plurality of individuals working for the same or different entities. Accordingly, the steps of methods 400 and 500 may each be performed by the same or a different person, each located at an assembly location. As an example, the AC PV module installer may be a combination of mechanics and electricians.

Referring to FIG. 5, an example of a method of assembling an AC PV module, such as AC PV module 300, is indicated generally at 400. In this embodiment, method 400 includes: receiving 401 a DC PV module and a micro-inverter at an assembly location, assembling 402 an AC PV module at the assembly location, testing 403 the AC PV module DC electrical continuity at the assembly location, and labeling 404 the AC PV module certified compliant with a standard at the assembly location.

In the example method 400, receiving 401 a DC PV module and a micro-inverter at the assembly location includes receiving the DC PV module and the micro-inverter from the same supplier, distributor, and/or manufacturer. In other embodiments, receiving 401 includes receiving the DC PV module and the micro-inverter from different suppliers, distributors, and/or manufacturers.

Assembling 402 an AC PV module at the assembly location includes connecting a first DC electrical connector (e.g., connector 306) on a DC PV module to a second DC electrical connector (e.g., connector 310) on a micro-inverter at the assembly location. Assembling the AC PV module may also include connecting a third DC electrical connector (e.g., connector 308) on the DC PV module to a fourth DC electrical connector (e.g., connector 312) on the micro-inverter. Assembling the AC PV module may also include mechanically attaching and electrically grounding the micro-inverter to the DC PV module. For example, as illustrated in FIG. 4, micro-inverter 304 is mechanically attached and grounded to the DC PV module (i.e., solar module 100) by a fastener 301 extending through frame 104 and engaging micro-inverter 304. In some embodiments, assembling the AC PV module may also include mechanically attaching and electrically grounding the micro-inverter to the DC PV module such that the micro-inverter is not otherwise grounded to the DC PV module. Assembling the AC PV module may include inserting a first and second AC electrical connector (e.g., connectors 330 and 332) between a frame and a laminate of the DC PV module. Assembling the AC PV module may also include securing the first and second AC electrical connectors to the frame of the DC PV module. In another example, assembling the AC PV module includes securing the first AC electrical connector to the frame of the DC PV module and securing the second AC electrical connector to the frame of an adjacent AC PV module (e.g., after the second AC electrical connector is connected to a corresponding AC electrical connector on the adjacent AC PV module). In yet another example, as shown in FIG. 4, the first AC electrical connector may be secured and/or attached between the frame and the laminate of the DC PV module at a distance from where the second AC electrical connector is secured and/or attached between the frame and the laminate of the DC PV module.

Testing 403 the AC PV module includes testing DC electrical continuity between the DC PV module and the micro-inverter at the assembly location. In the example embodiment, the electrical continuity testing is performed as defined by UL Standard 1703, Section 45. Testing the AC PV module may include, for example, connecting a meter between the DC PV module and the micro-inverter to receive an indication of DC electrical continuity. The meter may include, for example, a voltmeter, an ammeter, or an ohmmeter. In alternative embodiment, testing 403 includes testing the connection between the DC PV module and the micro-inverter for compliance with a code or standard. Examples of such codes and standards are provided above.

Labeling 404 the AC PV module includes labeling the AC PV module as certified compliant with an electrical code or standard, a mechanical code or standard, a manufacturing code or standard, and/or a safety code or standard at the assembly location. In the exemplary embodiment, labeling 404 the AC PV module as certified compliant with an electrical code or standard occurs after the AC PV module is tested and certified compliant with the applicable code or standard. Examples of such codes and standards are provided above.

Referring to FIG. 6, an example of a method of assembling a PV system, including at least two AC PV modules, is indicated generally indicated at 500. In this embodiment, method 500 includes: receiving 501 a first DC PV module and a first micro-inverter at an assembly location, assembling 502 a first AC PV module at the assembly location, testing 503 the first AC PV module DC electrical continuity at the assembly location, labeling 504 the first AC PV module certified compliant with a standard at the assembly location, receiving 505 a second DC PV module and a second micro-inverter at the assembly location, assembling 506 a second AC PV module at the assembly location, testing 507 the second AC PV module DC electrical continuity at the assembly location, labeling 508 the second AC PV module certified compliant with a standard at the assembly location, connecting 509 the first AC PV module to the second AC PV module to form a PV system, and mapping 510 the PV system.

The example method 500 includes receiving 501 a first DC PV module and a first micro-inverter and receiving 505 a second DC PV module and a second micro-inverter. In the example embodiment, the first and second DC PV module and the first and second micro-inverter are received at the assembly location. The first DC PV module and the first micro-inverter may be received at the same or a different time than the second DC PV module and micro-inverter.

Assembling 502 a first AC PV module at the assembly location includes connecting a first DC electrical connector (e.g., connector 306) on a first DC PV module to a second DC electrical connector (e.g., connector 310) on a first micro-inverter at the assembly location. Assembling the first AC PV module may also include connecting a third DC electrical connector (e.g., connector 308) on the first DC PV module to a fourth DC electrical connector (e.g., connector 312) on the first micro-inverter. Similarly, assembling 506 the second AC PV module includes connecting a first DC electrical connector (e.g., connector 306) on a second DC PV module to a second DC electrical connector (e.g., connector 310) on a second micro-inverter at the assembly location. Assembling the second AC PV module may also include connecting a third DC electrical connector (e.g., connector 308) on the second DC PV module to a fourth DC electrical connector (e.g., connector 312) on the second micro-inverter. In the example embodiment, the first and second AC PV modules may be assembled at the same or different times.

Testing 503 the first AC PV module includes testing the DC electrical continuity between the first DC PV module and the first micro-inverter at the assembly location. Similarly, testing 507 the second AC PV module includes testing the DC electrical continuity between the second DC PV module and the second micro-inverter at the assembly location. Testing 503 and 507 may include, for example, connecting a meter between the first and second DC PV module and the first and second micro-inverter, respectively, to receive an indication of DC electrical continuity. In the example embodiment, testing 503 and 507 are performed at different times. In alternative embodiments, testing 503 and 507 may be performed at the same time.

The method 500 includes labeling 504 the first AC PV module as certified compliant with a code or standard at the assembly location and labeling 508 the second AC PV module as certified compliant with a code or standard at the assembly location. Examples of such codes and standards are provided above. In the example embodiment, labeling 504 and 508 are performed at different times. In alternative embodiments, labeling 504 and 508 may be performed at the same time.

In the example method 500, a PV system is formed by connecting 509 the first AC PV module to the second AC PV module at the assembly location. Connecting 509 includes connecting a first AC electrical connector on the first micro-inverter to a second AC electrical connector on the second micro-inverter at the assembly location. Connecting 509 may also include connecting a third AC electrical connector on the first micro-inverter to a utility grid. Connecting 509 may also include connecting a fourth AC electrical connector on the second micro-inverter to an end cap. In some embodiments, connecting 509 may include connecting a meter between the first and second micro-inverter to receive an indication of AC electrical continuity. Connecting 509 may also include connecting a meter between the first or second micro-inverter and the utility to receive an indication of AC electrical continuity. In another embodiment, connecting 509 may include a PV system is formed from a plurality of (i.e., more than two) AC PV modules. In yet another embodiment, connecting 509 includes installation of one or more AC PV modules at the assembly location.

Mapping 510 the PV system includes mapping the PV system by recording a location of the AC PV modules in the PV system at the assembly location. Mapping 510 may also include recording a location of the AC electrical connection between the various AC PV modules and the utility grid. Recording locations of the AC PV modules includes recording serial numbers from the various AC PV modules. Recording locations of the AC PV modules may also be accomplished using global positioning software.

Embodiments of the methods described herein provide distinct advantages compared to prior methods. For example, the electrical connection between DC PV modules and micro-inverters from different manufacturers and distributors may be certified compliant with the requirements of various codes and standards. Moreover, existing business relationships between DC PV module and micro-inverter manufacturers and PV module installers would yield/create a more cost-beneficial scenario for AC PV module customers. More specifically, the methods described herein provide a method for field assembling an AC PV module from DC PV modules and micro-inverters without voiding the DC PV module or micro-inverter warranties.

The methods described herein further permit an AC PV module installer or customer to delay configuring the module and PV system until moments before the module or assembly is installed at an assembly location. More specifically, an AC PV module installer can decide at the assembly location whether to have (i) a DC PV module array with a centralized inverter, or (ii) a DC PV module array, each DC PV module with a micro-inverter. Moreover, the example methods may reduce overhead and labor costs at the DC PV module and micro-inverter manufacturing facilities which no longer have to handle and assemble the AC PV modules. Further, vertically integrated entities are able to take advantage of their business structure and shift time requirements and costs from their manufacturing facilities to their on-site assembly and support personnel.

When introducing elements of the present disclosure or the embodiments thereof, the articles “a”, “an”, “the” and “said” are intended to mean that there are one or more of the elements. The terms “comprising”, “including” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying figures shall be interpreted as illustrated and not in a limiting sense.

What is claimed is:

1. A method of assembling a photovoltaic (PV) system at an assembly location, the PV system comprising a first alternating current (AC) PV module and a second AC PV module, each AC PV module including a direct current (DC) PV module and a micro-inverter, the method comprising:
assembling, by a PV system installer at the assembly location, the first AC PV module by connecting a first DC electrical connector on a first DC PV module to a second DC electrical connector on a first micro-inverter;
testing, at the assembly location, a DC electrical continuity between the first DC PV module and the first micro-inverter;
labeling, at the assembly location, the first AC PV module as certified compliant with the code or standard;
assembling, by the PV system installer at the assembly location, the second AC PV module by connecting a third DC electrical connector on a second DC PV module to a fourth DC electrical connector on a second micro-inverter;
testing, at the assembly location, a DC electrical continuity between the second DC PV module and the second micro-inverter;
labeling, at the assembly location, the second AC PV module as certified compliant with a code or standard; and
connecting, at the assembly location, the first AC PV module to the second AC PV module by connecting a first AC electrical connector on the first micro-inverter to a second AC electrical connector on the second micro-inverter.

2. The method of claim 1 further comprising connecting a third AC electrical connector on the first micro-inverter to a utility grid.

3. The method of claim 2 further comprising connecting a fourth AC electrical connector on the second micro-inverter to an end cap.

4. The method of claim 1 further comprising testing the AC electrical continuity between the first and second AC electrical connectors.

5. The method of claim 2 further comprising testing the AC electrical continuity between the third AC electrical connector and the utility grid.

6. The method of claim 2 further comprising mapping the PV system by recording a location of the first AC PV module, a location of the second AC PV module, and a location of the connection between the third AC electrical connector and the utility grid.

7. The method of claim 6 wherein mapping the PV system includes recording serial numbers from the first and second AC PV modules.

8. The method of claim 1 wherein testing the DC electrical continuity between the first DC PV module and the first micro-inverter, labeling the first AC PV module, testing the DC electrical continuity between the second DC PV module and the second micro-inverter, and labeling the second AC PV module are performed by the AC PV module installer.

9. A method of assembling an alternating current (AC) photovoltaic (PV) module including a direct current (DC) PV module and a micro-inverter, the DC PV module including a frame, the method comprising:
assembling, by an AC PV module installer at an assembly location, the AC PV module by mechanically attaching and electrically grounding the micro-inverter to the DC PV module, connecting a first DC electrical connector on the DC PV module to a second DC electrical connector on the micro-inverter, and securing a first AC electrical connector on the micro-inverter to the frame of the DC PV module;
testing, at the assembly location, a DC electrical continuity between the DC PV module and the micro-inverter; and
labeling, at the assembly location, the AC PV module as certified compliant with a code or standard.

10. The method of claim 9 wherein assembling the AC PV module further comprises connecting a third DC electrical connector on the DC PV module to a fourth DC electrical connector on the micro-inverter.

11. The method of claim 9 wherein the micro-inverter is mechanically attached and grounded to the DC PV module by a fastener extending through the frame and engaging the micro-inverter.

12. The method of claim 9 wherein the micro-inverter is not otherwise grounded to the DC PV module.

13. The method of claim 9 wherein labeling the AC PV module comprises labeling the AC PV module as certified compliant with an electrical standard UL 1741.

14. The method of claim 9 wherein labeling the AC PV module comprises labeling the AC PV module as certified compliant with an electrical standard NEC section 690 and 705.

15. The method of claim 9 wherein labeling the AC PV module comprises labeling the AC PV module as certified compliant with a safety standard.

16. The method of claim 9 wherein the assembly location is at an installation site of the AC PV module.

17. The method of claim 9 wherein the AC PV module assembly location is not at a location of a manufacturer of the DC PV module.

18. The method of claim 9 wherein the AC PV module assembly location is not at a location of a manufacturer of the micro-inverter.

19. The method of claim 9 further comprising receiving, at the assembly location, the DC PV module and the micro-inverter.

20. The method of claim 19 wherein the DC PV module and the micro-inverter are received from a first supplier.

21. The method of claim 19 wherein the DC PV module is received from a first supplier and the micro-inverter is received from a second supplier.

22. The method of claim 9 wherein testing the DC electrical continuity and labeling the AC PV module is performed by the AC PV module installer.
